(19) United States
(12) Patent Application Publication
(10) Pub. No.: US 2010/0186373 A1
(43) Pub. Date: Jul. 29, 2010

(54) Exhaust Heating for Gensets

(76) Inventors: Patrick Pierz, Columbus, IN (US); Brian G. Haupt, Stillwater, MN (US); Shreyasee Kambale, Plymouth, MN (US); Bruce A. Peterson, Plymouth, MN (US); Dan G. Priem, Brooklyn Center, MN (US); Lowell K. Siewart, Brooklyn Park, MN (US); Karim Elayed, Sint-Stevens-Woluwe (BE)

Correspondence Address: KRIEG DEVAULT LLP, ONE INDIANA SQUARE, SUITE 2800, INDIANAPOLIS, IN, 46204-2079, US

(21) Appl. No.: 12/634,053

(22) Filed: Dec. 9, 2009

Related U.S. Application Data
(60) Provisional application No. 61/201,289, filed on Dec. 9, 2008.

(51) Int. Cl. F01N 3/027; F01N 3/021; H02K 7/18; H02P 9/02

(52) U.S. Cl. 60/274; 60/320; 60/295; 60/286; 290/1 R; 290/7

(57) ABSTRACT

An electric power system includes a genset with an electric power generator, an internal combustion engine driving the electric power generator, and an electric heating device. This device may be used to selectively regenerate an exhaust treatment subsystem and/or to otherwise selectively increase load on the engine. In one application, the system is carried by a vehicle propelled by another engine. In another application, the system is structured to provide back-up power to an AC power bus, and is typically stationary.

### CROSS-REFERENCE TO RELATED APPLICATIONS

The present application claims the benefit of U.S. provisional patent application No. 61/201,289 filed on Dec. 9, 2008, which is hereby incorporated by reference in its entirety.

### BACKGROUND

The present application relates to generator/engine sets, and more particularly, but not exclusively, relates to selective heating of exhaust from a generator/engine set.

Electric power generator/engine sets find application as stationary primary power sources (either independent of or coupled to a public power grid), backup power sources, and as auxiliary power sources for vehicles that include one or more other engines/sources for propulsive power—just to name a few. While emissions control has typically focused on larger engines used for propulsion, under some circumstances it is also desirable to control emissions from generator/engine sets. Certain emission treatment devices require elevated temperatures to perform device regeneration from time-to-time. Typically, the engine is controlled to provide this temperature elevation with a hotter exhaust stream than during non-regeneration. Unfortunately, this approach can be undesirable or impractical for lightly loaded and/or smaller engines often associated with generator/engine sets. Moreover, light or no load operation of various generator/engine sets can have various deleterious effects either with or without undesired emissions. Accordingly, there is a demand for further contributions in this area of technology.

### SUMMARY

One embodiment of the present application is a unique genset. Other embodiments include unique methods, systems, devices, and apparatus involving exhaust temperature and/or load control of a genset. Further objects, forms, embodiments, benefits, advantages, features, and aspects of the present application shall become apparent from the description and drawings contained herein.

### BRIEF DESCRIPTION OF THE FIGURES

FIG. 1 is a partial schematic view of a vehicle including a primary engine system for motive power and an auxiliary power system for electrical power.

FIG. 2 is a schematic view showing further details of the auxiliary power system.

FIG. 3 is a flow chart illustrating a regeneration routine for an exhaust treatment device of the auxiliary power system.

FIG. 4 is a schematic view of a back-up electric power system.

FIG. 5 is a flow chart illustrating a routine for utilizing the electric heating device shown in the system of FIG. 4.

### DETAILED DESCRIPTION OF REPRESENTATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the illustrated or described embodiments, and further applications of the principles of the application as would normally occur to one skilled in the art to which the invention relates are contemplated and protected.

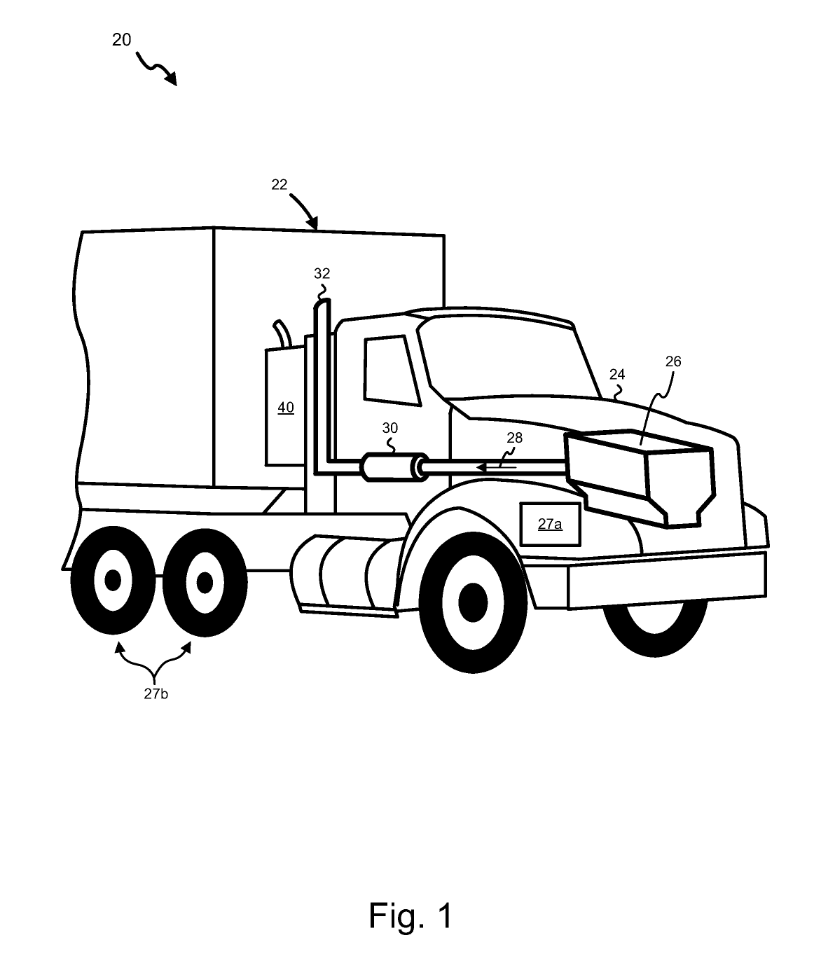

FIG. 1 depicts a partial schematic view of a vehicle system 20 of one embodiment of the present invention. Vehicle system 20 includes tractor-trailer truck 22, which includes cab 24 and primary internal combustion engine 26. Engine 26 provides vehicular propulsive power for vehicle system 20. This propulsive power is transmitted by drive train 27a to wheels 27b. Engine 26 is coupled to primary engine exhaust treatment system 30, which is inline with primary engine exhaust stream 28. Engine 26 may be of a multiple, reciprocating piston type that is diesel-fueled; however, in other embodiments, engine 26 may be differently configured and/or operate with a different fuel. Treatment system 30 forms a conduit, which carries exhaust gas of stream 28 from primary engine 26 to treated exhaust outlet 32. In one form, exhaust treatment system 30 includes at least a diesel particulate filter (DPF) that is regenerated from time-to-time. Additionally or alternatively, treatment system 30 includes a catalytic bed to remove nitrogen oxide(s) and/or one or more undesired sulfur-based compounds. In one specific example, after-treatment may be performed with or without providing a dosing material such as a hydrocarbon, urea, ammonia, or the like.

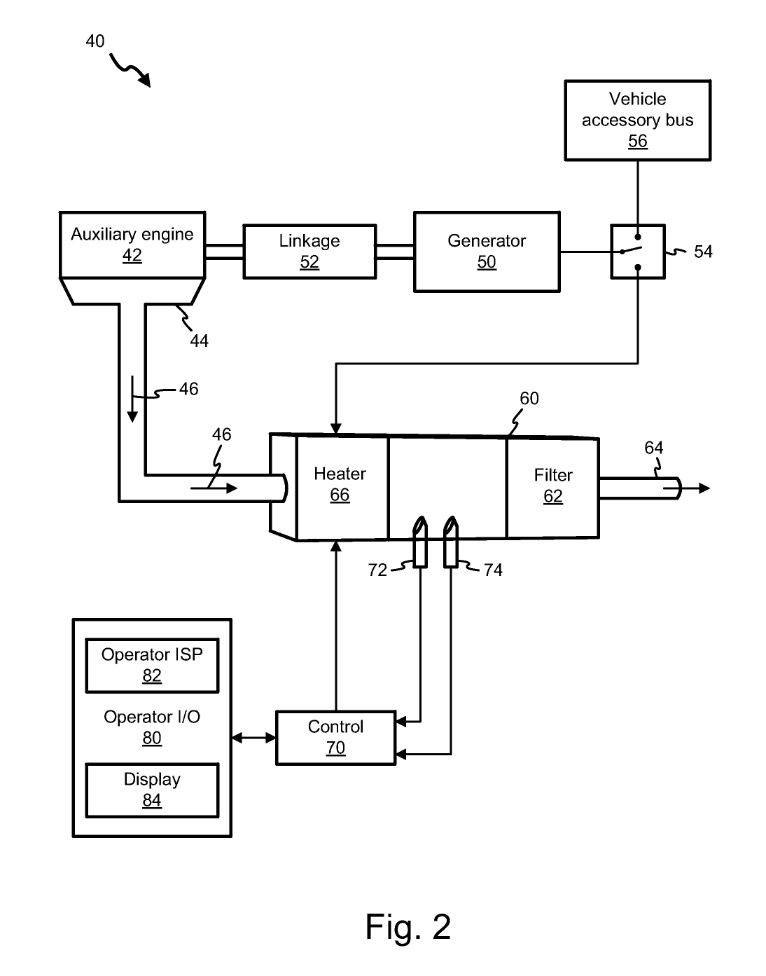

Vehicle system 20 also includes auxiliary power system (APS) 40, which is dedicated to powering vehicle accessories. FIG. 2 depicts a schematic view showing further details of auxiliary power system 40. APS 40 includes auxiliary internal combustion engine 42, having exhaust manifold 44 coupled to auxiliary engine exhaust treatment device 60 via auxiliary exhaust stream 46. Exhaust from engine 42 travels through exhaust stream 46 to treatment device 60 and then, after being treated is released through treated exhaust outlet 64. Auxiliary engine 42 is coupled to electrical generator 50 via mechanical linkage 52, which may take the form of a direct drive shaft, belt, gears, and/or a different form of rotary linkage as would occur to those skilled in the art. Collectively, engine 42, generator 50, and linkage 52 provide a genset to provide electric power. This genset may be of a fixed or a variable speed type and may be fueled by diesel fuel, gasoline, or a different fuel type.

APS 40 further includes vehicle accessory electrical bus 56, which may be used for powering refrigerators, air conditioners, pumps, or any other electrical devices as required for vehicle system 20. APS 40 further includes switch 54 in the form of a relay, which is structured to selectively route an electric power output of generator 50.

Auxiliary engine exhaust treatment device 60 includes regeneration device 66 in the form of a heating device or heater 67 which is electrically powered and serves to selectively heat the exhaust coming from engine 42, under certain conditions. Treatment device 60 further includes particulate matter filter 62, which serves to filter the exhaust of engine 42. Treatment device 60 also includes pressure sensor 72, which may be of a standard type, and is operable to produce a pressure signal indicative of exhaust pressure within treatment device 60 and upstream of filter 62. It should be appreciated, that as filter 62 traps particulate matter, pressure upstream of filter 62 generally increases, which can be monitored with this pressure signal. Treatment device 60 further includes temperature sensor 74, which may be of a standard type, and is operable to provide a signal representative of the absolute temperature of exhaust within treatment device 60. In addition to or instead of filter 62, treatment device 60 may include one or more other emission control devices, such as a catalytic bed to reduce nitrogen oxide(s), one or more sulfur-based compounds, or the like with or without dosing.

APS 40 further includes control 70, which may be an electronic circuit comprised of one or more components, including digital circuitry, analog circuitry, or both. Control 70 operates in accordance with operating logic that may be in the form of software, firmware, a hardwired dedicated state machine, or a combination of these. In one particular embodiment, control 70 is in the form of a microcontroller or microprocessor that is embedded with nonvolatile memory in which operating logic is stored in the form of programming instructions executable therewith. Nonetheless, in other forms a different type of control 70 may be utilized. Control 70 is coupled to operator input/output (I/O) 80, which includes operator input device 82, and display 84. Operator input 82 can include one or more of: a keyboard, pointer, switches, or the like. Display 84 can include one or more of: an alarm, indicator, video display, Light Emitting Diode (LED) panel, or the like. Control 70 includes inputs for receiving signals from pressure sensor 72 and temperature sensor 74.

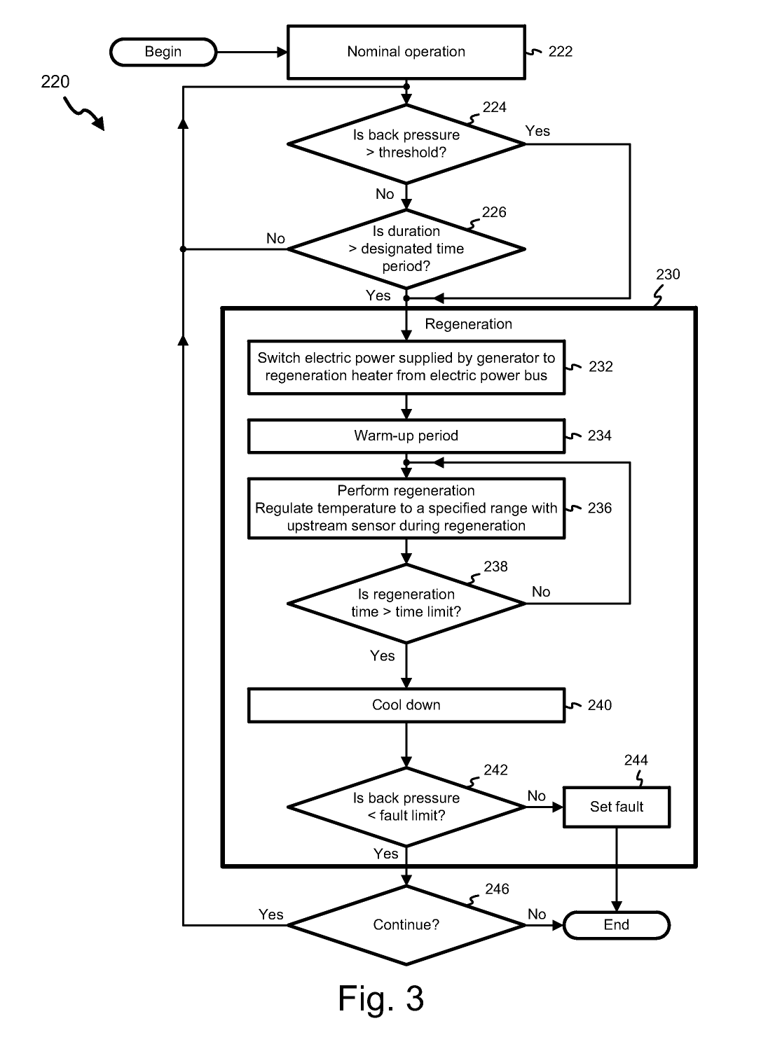

FIG. 3 depicts in flowchart form procedure 220, which is one possible auxiliary exhaust treatment approach that can be executed for APS 40. The operating logic of control 70 can be structured to perform appropriate aspects of procedure 220. Procedure 220 begins with operation 222, which represents nominal operation of APS 40. Procedure 220 continues with conditional 224, which compares exhaust back pressure, as measured by pressure sensor 72, to a predetermined threshold. It should be appreciated that conditional 224 is performed from time-to-time on a periodic or aperiodic basis as nominal operations of APS 40 proceed in accordance with operation 222. If back pressure is greater than this threshold, execution continues with regeneration routine 230. If back pressure is not greater than this threshold, procedure 220 continues with conditional 226. Conditional 226 compares APS 40 operational time to a predetermined threshold. If operational time is not greater than the threshold as tested by conditional 226, procedure 220 loops back to continue nominal operation 222 and repeat conditional 224. If operational time is greater than the threshold as tested by conditional 226, procedure 220 continues with routine 230.

Routine 230 serves to reduce particulate matter in filter 62 through oxidation (such as controlled burning) either aided or unaided by a catalyst. Routine 230 begins with operation 232, which switches electric power supplied by generator 50 from electrical bus 56 to heater 67. In an alternative approach, only a portion of the electric power is routed to heater 67, still providing electricity to bus 56. After completion of operation 232, procedure 230 continues with operation 234, which waits for a predetermined period to allow exhaust temperature to reach the level necessary for regeneration. After completion of operation 234, procedure 230 continues with operation 236. Operation 236 controls the exhaust temperature within treatment device 60 while regeneration is occurring. Exhaust temperature is controlled by changing the current and/or voltage supplied to heater 67. Exhaust temperature is maintained high enough for effective regeneration, but is limited to prevent damage to system components. After completion of operation 236, routine 230 continues with conditional 238, which compares regeneration time to a predetermined threshold. If the time does not exceed the threshold as tested by conditional 238, routine 230 continues with operation 236 as described previously. If the time exceeds the threshold as tested by conditional 238, routine 230 continues with operation 239, which switches electric power supplied to heater 67 by generator 50 back to electrical bus 56. After completion of operation 239, procedure 230 continues with operation 240. Operation 240 waits a predetermined time period to allow exhaust within treatment device 60 to cool down. During this cool down period, APS 40 will not respond to either automatic or manual commands to start or stop. After completion of operation 240, routine 230 continues with conditional 242, which compares back pressure, as measured by pressure sensor 72, to a predetermined threshold. If back pressure is less than this threshold as tested in conditional 242, it indicates regeneration was successful, and routine 230 ends. Procedure 220 then continues to conditional 246. If back pressure is not less than this threshold as tested by conditional 242, routine 230 continues to operation 244. Operation 244 is directed to set a fault indicating that system maintenance is required because regeneration routine 230 did not reduce pressure as expected. After completion of operation 244, routine 230 ends and procedure 220 continues with conditional 246.

Conditional 246 checks for an automatic or manual command to stop operation of APS 40. If no command has been received, execution loops back to conditional 222, which has been described previously. If a command has been received, procedure 220 ends.

As is evident from the figures and text presented above, a variety of embodiments of the present application are contemplated. Certain exemplary embodiments include a system, method, and apparatus for providing auxiliary power unit emissions management. It may be applied to vehicle or non-vehicle applications. For general vehicle-based embodiments, such vehicle may be of a land travel, marine, or aircraft variety. In one nonlimiting embodiment, the vehicle is a class 8 type of truck. Alternatively or additionally, it may be applied with any type of internal combustion engine, including intermittent combustion, multi-stroke varieties and continuous combustion types, such as various forms of gas turbine engine—to name just a couple of examples.

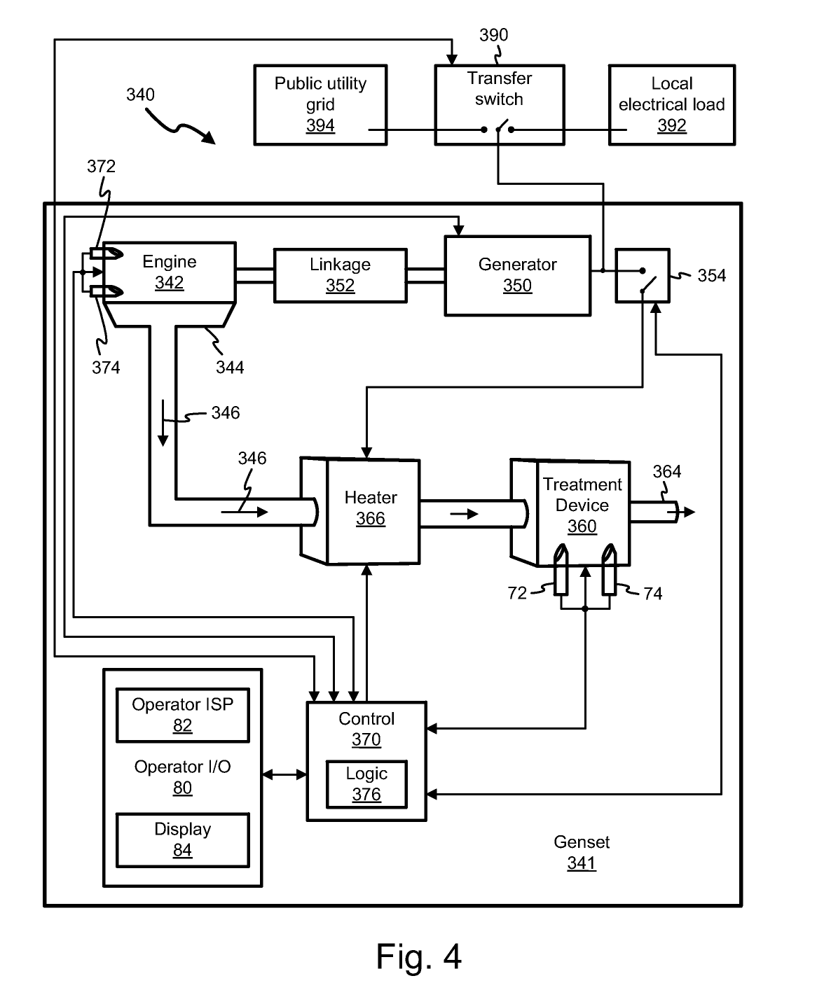

System 20 includes multiple engines directed to vehicle propulsion and auxiliary electric power generation, respectively; in other embodiments, a generator/engine may be used without a vehicle and/or propulsion engine for electric power generation—such as a primary or standby/back-up source. For example, FIG. 4 depicts a schematic view of the back-up power system 340; where like reference numerals refer to like features previously described.

System 340 includes genset 341 with internal combustion engine 342 and electric power generator 350. Engine 42 has exhaust manifold 344 coupled to auxiliary engine exhaust treatment device 360 via auxiliary exhaust stream 346. Exhaust from engine 342 travels along exhaust stream 346 to treatment device 360 and then, after being treated is released through treated exhaust outlet 364.

Engine 342 is coupled to electric power generator 350 via mechanical linkage 352, which, as indicated in earlier described embodiments may take any form such as, a direct drive shaft, belt, gears, and/or a different form of rotary linkage as would occur to those skilled in the art. Genset 341 may be of a fixed or variable speed type, maybe fueled by diesel fuel, gasoline, or a different fuel type, and/or may include any type of internal combustion engine or electric power generator structured to be driven by such engine. System 340 further includes switch 354, which may be in the form of a mechanical, electromechanical, and/or semiconductor relay, just to name a few examples. Switch 354 is structured to selectively route at least a portion of the electric power output from generator 50 to heating device 366. Heating device 366 is included along exhaust stream 346 upstream from exhaust treatment device 360. As previously described in connection with APS 40, heating device 366 may be used to selectively heat the exhaust coming from engine 342 under certain conditions. For such embodiments, treatment device 360 may further include a particulate matter filter, one or more catalytic beds, or the like that serve to condition/treat exhaust from engine 342 and would benefit from application of heated exhaust from heating device 366 from time to time. Treatment device 360 also includes pressure sensor 372 which may be of a standard type, and is operable to produce a pressure signal indicative of an exhaust pressure within treatment device 360 and/or upstream therefrom. It should be appreciated that for a filter application, such as that described in connection with APS 40, pressure sensor 72 may be utilized to monitor pressure and determine when it reaches a given threshold indicative of a need to regenerate or otherwise service the filter. Treatment device 360 further includes temperature sensor 74, which may be of a standard type, and is operable to provide a signal representative of the absolute temperature of exhaust within treatment device 360. Treatment device 360 may be of any type selected to control one or more aspects of emissions in the exhaust from engine 342, including, but not limited to those previously described.

System 340 further includes control 370, which may be an electronic circuit comprised of one or more components, including digital circuitry, analog circuitry, or both. Control 370 operates in accordance with operating logic 376 that may be in the form of software, firmware, a hardwired dedicated state machine, or a combination of these—just to name a few examples. In one particular embodiment, control 370 is in the form of a microcontroller or microprocessor that is embedded with nonvolatile memory in which operating logic is stored in the form of program instruction as executable therewith. Nonetheless, in other forms a different type of control 370 may be utilized. Control 370 is operatively coupled to operator I/O 80, which includes input device 82 and display 84 previously described. Control 370 may be configured to selectively monitor and/or actuate various aspects of the operation of treatment device 360, generator 350, and engine 342, switch 354, and heating device 366. In other embodiments, more or fewer devices may be controlled therewith. As depicted in FIG. 4, control 370 interfaces with temperature sensor 372 and temperature sensor 374. Sensor 372 and 374 may be of a standard type and are each operable to provide a signal representative of temperature. In the case of sensor 372, it provides control 370 a signal representative of coolant temperature for engine 342. In the case of sensor 374, it provides control 370 a signal representative of temperature of oil circulating in an oil subsystem of engine 342.

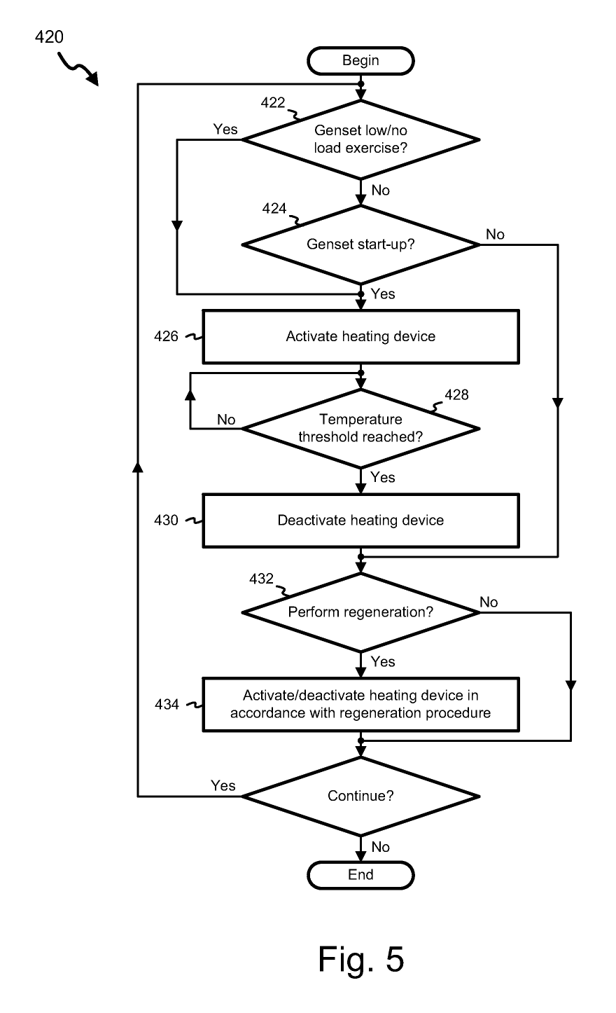

FIG. 5 depicts procedure 420 in flow chart form, which is one possible routine that can be executed with system 340. The operating logic 376 of control 370 can be structured to perform appropriate aspects of procedure 420.

System 340 further includes electric power transfer switch 390, local electrical load 392 at one pole of switch 390 and public utility grid 394 at another pole of switch 390. Further, transfer switch 390 is operatively coupled to control 370. Accordingly, control 370 can generate one or more signals to change the source of electrical power for local electrical load 392 between public utility grid 394 and genset 341. With this configuration, a standard stand-by or back-up power system is provided in which genset 341 is only utilized to power local electrical load 392 when the power from public utility grid 394 is unavailable and/or of unacceptable quality. Typically, such back-up configurations are utilized in various industries, including manufacturing facilities, hospitals, public buildings, data communications equipment locations, and the like.

It should be appreciated that for such stand-by generators, there is often a desire to test operation by exercising the genset while disconnected from the electrical load, that is while disconnected from both local electrical load 392 and public utility grid 394. It has been discovered; however, that during exercise under such light-load or essentially no-load conditions, very low engine exhaust temperatures result and only slowly heat the engine coolant and oil. As a result, unburned hydrocarbons in the form of light smoke are often present in the exhaust of internal combustion engines with hydrocarbon fuel. Moreover, the situation is exacerbated by ambient temperature decreases—keeping in mind that stand-by gensets are sometimes located outdoors or a less-sheltered environment in temperate environs. Alternatively or additionally, besides unburned hydrocarbons causing visible light smoke, another common problem results in that certain gases condense in the exhaust while at low temperature causing liquid fuel to collect and drip from connections associated with the genset. This undesired fuel emission is sometimes called “slobber.” In addition, low oil temperatures and the like may allow moisture from the conduction product to build up on the oil accelerating its degradation. Further, as in the depicted system 340, when an exhaust treatment device 360 is present, such as a particulate filter, catalytic bed or the like that requires regeneration, it is often desired to increase exhaust temperatures even during such light load/no load exercise.

Accordingly, procedure 420 begins with conditional 422, which tests whether the genset is undergoing a low or no-load exercise—typically for a stand-by/back-up genset this would entail electrical output of the genset being disconnected from any local load or other significant electrical load. If the test of conditional 422 is negative, procedure 420 continues with conditional 424 which tests whether the genset is in a start-up mode. If not, then conditional 420 proceeds to determine whether regeneration of treatment device 360 should be performed through the test of conditional 432. If not (no), conditional 436 is encountered which tests whether or not to continue procedure 420. If procedure 420 is to be continued, it loops back returning to repeat conditional 422.

If the test of conditional 422 is affirmative (yes), then procedure 420 continues by activating heating device 366 in operation 426. Conditional 428 is next encountered, which determines whether a temperature threshold has been reached—as provided by temperature sensor 74. This threshold temperature may be selected to counteract the effects of a low or no-load exercise. Similarly, if the test of conditional 424 is affirmative (yes) then heating device 366 is also activated by operation 426 and subject to the test of conditional 428 to determine whether a threshold temperature has been reached. In both cases, if the threshold temperature is not reached, procedure 420 returns to repeat conditional 428 until the desired temperature is reached, at which point procedure 420 continues with operation 430. In operation 430, heating device 366 is deactivated given that the desired temperature has been reached. From both the negative (no) branch of conditional 424 and from operation 430, conditional 432 is reached which tests whether or not to perform regeneration of treatment device 360. If the test is affirmative (yes) then operation 434 is performed. In operation 434, heating device 366 is activated and then deactivated in accordance with a regeneration procedure. This procedure may be like routine 230 previously described in connection with FIG. 3. Likewise, the test of conditional 432 may include a pressure signal comparison to a threshold as reflected in conditional 224 and/or the duration test provided by conditional 226 in procedure 220. From operation 434, procedure 420 continues with conditional 436, which tests whether or not to continue procedure 420. If procedure 420 is not continued, it halts. If it is continued as previously described, procedure 420 returns to repeat conditional 422 and subsequent conditionals and operations previously described in connection with FIG. 5.

It should be appreciated that in other embodiments to the present application, the genset may be applied to provide primary power in addition to or in lieu of stand-by/back-up power and correspondingly configured. Alternatively or additionally, the genset may not include any form of aftertreatment device and/or may not include an aftertreatment device that benefits from exhaust heating—indeed in some applications it is envisioned that procedure 420 will be utilized only in part for activating heating device 360 when in a low or no load circumstance and/or only upon genset start-up. In still other variations, activation may not be triggered by low/no load exercise and/or genset start-up.

It is envisioned that there are many different embodiments of the present application. One example includes operating a genset including an electric power generator and an internal combustion engine where the genset is one of a stationary installation type and a mobile type carried by a vehicle propelled by a prime mover other than the internal combustion engine of the genset; driving the electric power generator with the internal combustion engine during the operating of the genset; and during the driving of the electric power generator with the internal combustion engine, selectively providing electric power from the generator to operate an electric heating device to increase load on the internal combustion engine.

Another embodiment comprises: a genset including an electric power generator and an internal combustion engine. This genset is either of a stationary installation type or a mobile type carried by a vehicle. Also included is a means for driving the electric power generator with the internal combustion engine during the operating of the genset and means for selectively providing electric power to the generator to operate an electric heating device to increase load on the internal combustion engine during the driving of the electric power generator.

A further example comprises: operating a genset including an electric power generator and an internal combustion engine that has an exhaust pathway to discharge exhaust; dedicating the chemical output of the internal combustion engine to driving the electric power generator during the operating of the genset; selectively supplying electric power from the generator to an electric heating device positioned in the exhaust pathway of the engine as the internal combustion engine drives the electric power generator; and in response to the electric power, increasing temperature of the exhaust from the internal combustion engine.

Still another embodiment is an apparatus comprising: a genset including an electric power generator and an internal combustion engine that has an exhaust pathway to discharge exhaust. This apparatus further includes means for dedicating the chemical output of the internal combustion engine to driving the electric power generator during the operating of the genset; means for selectively supplying electric power from the generator to an electric heating device positioned in the exhaust pathway of the engine as the internal combustion engine drives the electric power generator; and means for increasing temperature of the exhaust from the internal combustion engine in response to the electric power.

In another embodiment, an apparatus includes a genset with an electric power generator and an internal combustion engine. The genset is of a stationary installation type or a mobile type carried by a vehicle. In one form, this vehicle is propelled by a prime mover other than the internal combustion engine and the internal combustion engine includes an exhaust pathway to discharge exhaust. Also, the apparatus includes an electric heating device to selectively increase load on the internal combustion engine. In certain embodiments, this electric heating device is positioned in the exhaust pathway of the internal combustion engine. Further, the apparatus includes a control with logic executable to selectively route electric power supplied from the electric power generator to the electric heating device to increase temperature of the exhaust from the internal combustion engine.

In a further example, one embodiment of the present application includes a vehicle with a first internal combustion engine system to provide vehicular propulsion and an auxiliary electric power system. The first internal combustion engine system includes a first exhaust treatment device to treat a first engine exhaust stream from the first internal combustion engine. The auxiliary electric power system includes an electric power generator, a second internal combustion engine to drive the generator, and a second exhaust treatment device to treat a second engine exhaust stream from the second internal combustion engine. The second exhaust treatment device includes a regeneration device. This device is electrically coupled to the generator to be powered by electricity produced by the generator during performance of a regeneration of the second exhaust treatment device therewith.

A further embodiment comprises: an auxiliary vehicular electric power system with vehicular propulsive power being provided by a different system. The auxiliary system includes: an electric power generator, an auxiliary internal combustion engine dedicated to driving the electric power generator, an auxiliary exhaust treatment device that includes a particulate filter and regeneration heater to treat an auxiliary engine exhaust stream from the auxiliary internal combustion engine, a temperature sensor to provide a temperature signal representing a temperature of this exhaust stream, and a control responsive to the temperature signal to a control operation of the heater during particulate filter regeneration as a function of the temperature of the exhaust stream. The heater is coupled to the electric power generator to be powered by electricity therefrom to perform the regeneration from time-to-time.

Another embodiment of the present application comprises: propelling a vehicle with a first internal combustion engine; treating a first engine exhaust stream from the first internal combustion engine with a first exhaust treatment device; carrying an auxiliary electric power system with the vehicle that includes an electric power generator, a second internal combustion engine and a second exhaust treatment device; driving the electric power generator with the second internal combustion engine to generate electricity; treating a second engine exhaust stream from the second internal combustion engine with the second exhaust treatment device; and regenerating the second exhaust treatment device. This regeneration includes providing at least a portion of the electricity to the second exhaust treatment device from the electric power generator.

Still another embodiment includes: a vehicle with a first internal combustion engine, means for treating a first engine exhaust stream from the first internal combustion engine with a first exhaust treatment device, means for carrying an auxiliary electric power system with the vehicle that includes an electric power generator, a second internal combustion engine, and a second exhaust treatment device, means for driving the electric power generator with the second internal combustion engine to generate electricity, means for treating a second engine exhaust stream from the second internal combustion engine with the second exhaust treatment device, and means for regenerating the second exhaust treatment device which includes providing at least a portion of the electricity to the second exhaust treatment device from the electric power generator.

Yet another embodiment includes: driving an electric power generator with an internal combustion engine, the internal combustion engine including an exhaust pathway to discharge exhaust; selectively coupling and decoupling an electric power output of the electric power generator to an electric power bus; during the driving of the electric power generator with the internal combustion engine, providing electric power from the generator to an electric heating device positioned in the exhaust pathway of the engine; and in response to the electric power, increasing temperature of the exhaust from the engine.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred, more preferred or exemplary utilized in the description above indicate that the feature so described may be more desirable or characteristic, nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A method, comprising:
operating a genset including an electric power generator and an internal combustion engine, the genset being one of: (a) a stationary installation type and (b) a mobile type carried by a vehicle propelled by a prime mover other than the internal combustion engine of the genset;
driving the electric power generator with the internal combustion engine during the operating of the genset; and
during the driving of the electric power generator with the internal combustion engine, selectively providing electric power from the generator to operate an electric heating device to increase load on the internal combustion engine.

2. The method of claim 1, wherein the internal combustion engine includes an exhaust pathway to discharge exhaust, the heating device is positioned in the exhaust pathway, and the electric heating device raises exhaust temperature during operation.

3. The method of claim 2, which includes regenerating an exhaust treatment device with the electric heating device.

4. The method of claim 1, wherein the genset is the mobile type and the prime mover is another internal combustion engine.

5. The method of claim 1, which includes
selectively coupling and decoupling an output of the electric power generator to an electric power bus, and
while decoupled from the electric power bus, exercising the genset which includes the providing of the electric power to operate the electric heating device.

6. The method of claim 1, wherein the genset is the stationary installation type structured to provide back-up AC electric power.

7. The method of claim 6, which includes:
powering the electric heating device with the electric power in response to start-up of the genset; and
selectively switching the electric power supplied to the electric heating device to another electrical load after the start-up of the genset.

8. A method, comprising:
operating a genset including an electric power generator and an internal combustion engine, the internal combustion engine including an exhaust pathway to discharge exhaust;
dedicating mechanical output of the internal combustion engine to driving the electric power generator during the operating of the genset;
as the internal combustion engine drives the electric power generator, selectively supplying electric power from the generator to an electric heating device positioned in the exhaust pathway of the engine; and
in response to the electric power, increasing temperature of the exhaust from the internal combustion engine.

9. The method of claim 8, which includes regenerating an exhaust treatment device with the electric heating device.

10. The method of claim 8, which includes carrying the genset with a vehicle propelled by another internal combustion engine.

11. The method of claim 8, which includes
selectively coupling and decoupling an output of the electric power generator to an electric power bus, and
while decoupled from the electric power bus, exercising the genset which includes the supplying of the electric power to operate the electric heating device.

12. The method of claim 8, wherein the genset is a stationary installation type structured to provide back-up electric power.

13. The method of claim 12, which includes:
powering the electric heating device with the electric power in response to start-up of the genset; and
selectively switching the electric power supplied to the electric heating device to another electrical load after the start-up of the genset.

14. An apparatus, comprising:
a genset including an electric power generator and an internal combustion engine, the genset being one of: (a) a stationary installation type and (b) a mobile type carried by a vehicle propelled by a prime mover other than the internal combustion engine, the internal combustion engine including an exhaust pathway to discharge exhaust;
an electric heating device positioned in the exhaust pathway; and
a control with executable logic to selectively route electric power supplied from the electric power generator to the electric heating device to increase temperature of the exhaust from the internal combustion engine.

15. The apparatus of claim 14 further comprising an exhaust treatment device positioned in the exhaust pathway downstream from the electric heating device.

16. The apparatus of claim 15, further comprising means for regenerating the exhaust treatment device.

17. The apparatus of claim 14, wherein the genset is the mobile type and the prime mover is another internal combustion engine.

18. The apparatus of claim 14, further comprising a transfer switch to selectively couple and decouple an output of the electric power generator to an electric power bus, and wherein the genset is the stationary installation type structured to provide back-up AC electric power.

19. The apparatus of claim 18, further comprising means for exercising the genset while the electric power is supplied to the electric heating device and the transfer switch is decoupled from the electric power bus.

20. The apparatus of claim 14, further comprising:
means for powering the electric heating device with the electric power in response to start-up of the genset; and
means for selectively switching the electric power supplied to the electric heating device to another electrical load after the start-up of the genset.

21. An apparatus, comprising: a vehicle, including:
a first internal combustion engine system to provide vehicular propulsion, the first internal combustion engine system including a first exhaust treatment device to treat a first engine exhaust stream from the first internal combustion engine; and
an auxiliary electric power system including an electric power generator, a second internal combustion engine to drive the generator, and a second exhaust treatment device to treat a second engine exhaust stream from the second internal combustion engine, the second exhaust treatment device including a regeneration device, the regeneration device being electrically coupled to the generator to be powered by electricity produced by the generator during performance of a regeneration of the second exhaust treatment device therewith.

22. The apparatus of claim 21, wherein the second exhaust treatment device includes a particulate filter and the regeneration device includes a heating element powered the electricity.

23. The apparatus of claim 21, further comprising:
a temperature sensor to provide a temperature signal representative of temperature of the second engine exhaust stream; and
a control responsive to the temperature signal to control operation of the regeneration device during the regeneration as a function of the temperature of the second engine exhaust stream.

24. The apparatus of claim 21, further comprising:
a pressure sensor to provide a pressure signal representative of pressure in the second engine exhaust stream upstream from the second exhaust treatment device;
a control responsive to the pressure signal to control operation of the regeneration device during the regeneration as a function of the pressure signal of the second engine exhaust stream.

25. The apparatus of claim 21, further comprising means for controlling operation of the regeneration device as a function of at least one of temperature and pressure of the second engine exhaust stream, the controlling means including means for determining when to perform the regeneration.

26. The apparatus of claim 21, further comprising a switch device electrically coupled to the electric power generator to route electric power therefrom, the switch device including a first output electrically coupled to an electric power bus to electrically power one or more accessories of vehicle and a second output electrically coupled to the regeneration device.

27. The apparatus of claim 26, where the switch device is responsive to means for controlling the regeneration to route the electricity to the regeneration device during the regeneration of the second exhaust treatment device and to route electric power to the electric power when the regeneration is not being performed.

28. An apparatus, comprising: an auxiliary vehicular electric power system with vehicular propulsive power being provided by a different system, including:
an electric power generator;
an auxiliary internal combustion engine dedicated to driving the electric power generator;
an auxiliary exhaust treatment device to treat an auxiliary engine exhaust stream from the auxiliary internal combustion engine, the auxiliary exhaust treatment device including a particulate filter and a heater, the heater being coupled to the electric power generator to be powered by electricity from the electric power generator to perform a regeneration of the particulate filter from time-to-time;
a temperature sensor to provide a temperature signal representative of temperature of the auxiliary engine exhaust stream; and
a control responsive to the temperature signal to control operation of the heater during the regeneration as a function of the temperature of the auxiliary engine exhaust stream.

29. The apparatus of claim 28, further comprising a vehicle carrying the auxiliary vehicular electric power system and a primary internal combustion engine to provide the vehicular propulsive power for the vehicle.

30. The apparatus of claim 28, further comprising:
a pressure sensor to provide a pressure signal representative of pressure in the auxiliary exhaust stream upstream from the auxiliary exhaust treatment device;
a control responsive to the pressure signal to control operation of the heater during the regeneration as a function of the pressure signal of the auxiliary engine exhaust stream.

31. The apparatus of claim 28, further comprising means for controlling operation of the regeneration device as a function of at least one of the temperature and pressure of the auxiliary engine exhaust stream, the controlling means including means for determining when to perform the regeneration.

32. The apparatus of claim 28, further comprising a switch device electrically coupled to the electric power generator to route electric power therefrom, the switch device including a first output electrically coupled to an electric power bus to electrically power one or more vehicle accessories and a second output electrically coupled to the heater.

33. The apparatus of claim 32, where the switch device is responsive to means for controlling the regeneration to route the electricity to the heater during the regeneration of the particulate filter and to route electric power to the electric power bus when the regeneration is not being performed.

34. A method, comprising:
propelling a vehicle with a first internal combustion engine;
treating a first engine exhaust stream from the first internal combustion engine with a first exhaust treatment device;
carrying an auxiliary electric power system with the vehicle, the auxiliary electric power system including an electric power generator, a second internal combustion engine, and a second exhaust treatment device;
driving the electric power generator with the second internal combustion engine to generate electricity;
treating a second engine exhaust stream from the second internal combustion engine with the second exhaust treatment device; and
regenerating the second exhaust treatment device, which includes providing at least a portion of the electricity to the second exhaust treatment device from the electric power generator.

35. The method of claim 34, which includes:
sensing temperature of the second engine exhaust stream;
controlling the regenerating of the second exhaust treatment device as a function of the temperature.

36. The method of claim 35, which includes
sensing pressure of the second engine exhaust stream;
sensing temperature of the second engine exhaust stream;
controlling the regenerating of the second exhaust treatment device as a function of the pressure and the temperature.

37. The method of claim 36, wherein the controlling includes determining when to perform the regenerating of the second exhaust treatment device as a function of the pressure.

38. The method of claim 34, wherein the second exhaust treatment device includes a heater and the regenerating of the second exhaust treatment device includes powering the heater with the electricity.

39. The method of claim 38, wherein the second exhaust treatment device includes an electrically powered regeneration device, and which includes:
powering a vehicle accessory electrical bus with the electricity;
monitoring one or more conditions corresponding to operation of the second engine exhaust stream; and
in response to a change in the one or more conditions, switching the at least a portion of the electricity from the vehicle accessory electrical bus to the electrically powered regeneration device to perform the regenerating of the second exhaust treatment device.

40. The method of claim 34, wherein the second exhaust treatment device includes a particulate filter.
